(19) United States
(12) Patent Application Publication
(10) Pub. No.: US 2016/0212819 A1
(43) Pub. Date: Jul. 21, 2016

(54) LED DRIVER AND DRIVING METHOD

(71) Applicant: PHILIPS LIGHTING HOLDING B.V., Eindhoven (NL)

(72) Inventors: ETIENNE NICHOLAAS KATHALIJNTJE PAULUS MARIE EBERSON, ECHT (NL); CHRISTIAN KALKSCHMIDT, AACHEN (DE); JOSEPH HENDRIK ANNA MARIA JACOBS, EYGELSHOVEN (NL)

(21) Appl. No.: 14/913,117

(22) PCT Filed: Aug. 6, 2014
(86) PCT No.: PCT/EP2014/066888

§ 371 Date: Feb. 19, 2016

(30) Foreign Application Priority Data
Aug. 19, 2013 (EP) 13180926.1

(51) Int. Cl. H05B 33/08

(52) U.S. Cl. CPC H05B 33/0887; H05B 33/0815

(57) ABSTRACT

An LED driver uses a current setting passive component to set an operating current, and also uses a voltage setting passive component to derive an acceptable voltage range. A current driver is then controlled to deliver the current setting and monitor that a voltage being provided is within the acceptable voltage range.

### FIELD OF THE INVENTION

This invention relates to an LED driver and driving method.

### BACKGROUND OF THE INVENTION

In this description and claims, the term “LED” will be used to denote both organic and inorganic LED's, and the invention can be applied to both categories. LEDs are current driven lighting units. They are driven using an LED driver which delivers a desired current to the LED.

The required current to be supplied varies for different lighting units, and for different configurations of lighting unit. The latest LED drivers are designed to have sufficient flexibility that they can be used for a wide range of different lighting units, and for a range of numbers of lighting units.

To enable this flexibility, it is known for the driver to operate within a so-called “operating window”. An operating window defines a relationship between the output voltage and output current than can be delivered by the driver. Providing the requirements of a particular lighting load fall within this operating window, the driver is able to be configured for use with that particular lighting load, giving the desired driver flexibility.

There may be multiple staked operating windows, each for a different power output version of the same driver architecture, so that a wide number of LED units can be operated by the same driver family.

This means a driver is able to be used for LED units of different design and from different manufacturers and for a wide range of applications, providing that the required current and voltage setting fits the operating window. It also enables lighting generation upgrades without changing the driver.

The driver needs to have its output current set to the desired level within its operating window. This can be achieved by programming the driver to deliver a specific current.

However, an alternative which enables a less complicated interface for the user is to provide current setting using a setting component, such as a resistor, outside the driver. This setting resistor can for example be placed on a PCB which provides the interface between the driver and the LED terminals, or the resistor can be integrated as part of a connection cable or connector unit.

The value of the current setting resistor (or other component) is measured by the driver, which can then configure its output accordingly, so that the output current is determined by the resistance value.

Once the current has been set, the voltage delivered by the driver will vary depending on the load presented to it (since the LEDs are current driven), but the driver will maintain this voltage within the operating window.

One of the drawbacks of the known use of operating window setting is that even when the current has been set, the range of voltages which may be delivered by the driver is very large, and can thus vary largely from the voltage which results from the LED when functioning normally. Thus, the driver may not be able to detect error conditions.

For example, if the operating window of the driver has a large range, an LED with a nominal operating point of a low voltage in that range can be driven up to much higher voltages and therefore much greater power without any problems detected at the driver side. The LED may then be driven at multiple times its nominal power, and will become hot and possibly can cause unsafe situations.

Another side effect is that when driven at much higher than nominal power, the LED will degrade very rapidly.

Current arrangements do not enable the driver to be aware of a suitable voltage range for the load.

### SUMMARY OF THE INVENTION

The invention is defined by the claims.

According to one aspect, there is provided an LED driver, comprising: a current setting input for connection to a current setting passive component;

a voltage setting input for connection to a voltage or power setting passive component;

a measuring circuit for measuring a characteristic value of the current setting passive component and a characteristic value of the voltage setting passive component;

a controller; and

a current driver,

wherein the controller is adapted to:

derive a current setting for the current driver from the current setting characteristic value;

derive an acceptable voltage or power range from the voltage setting characteristic value; and

control the current driver to deliver the current setting and monitor the output voltage or power to determine whether or not it falls within the acceptable range.

This LED driver makes use of two setting components. They are passive components, having a characteristic value which can be measured. This characteristic value can be an impedance, such as a resistance, capacitance or inductance, or it can be another value related to the performance of the component. For example, the characteristic can be a threshold value of a component such as a Zener diode.

In one example, the components are both resistors. These resistors are selected in dependence on the particular lighting load, in particular the impedance i.e. resistance value is selected One is used to determine the desired output current for the particular load (in known manner) and the other is used to derive a voltage or power range of operation.

For a given current, setting a voltage range and setting a power range equate to the same approach. Thus, the approach may be considered to be voltage setting or power setting. This is referred to as voltage/power below.

In this way, the LED driver can derive the specification of the connected load. By defining an acceptable voltage/power range, the driver is able to maintain a valid and safe operation of the load.

The driver preferably comprises an operating window driver having a current-voltage operating window.

The acceptable voltage/power range can then comprise upper and lower boundaries, wherein at most one of the upper and lower boundaries is on the edge of the current-voltage window. Thus, one boundary can be on the edge of the current-voltage window, and the other boundary is different to the original window.

In this way, the voltage/power range is smaller than would otherwise be defined by the operating window of the driver. The voltage/power range can be such that neither of the upper and lower acceptable voltage/power boundaries are on the edge of the current-voltage window. In addition to upper and lower boundaries, a nominal working point can also be defined.

The driver can further comprise a look up table for deriving a current setting from the current setting resistor value. Instead, the current setting can be derived by an algorithm.

The acceptable voltage/power range can be derived from the voltage or power setting resistor value by applying a first equation to derive the lower boundary and by applying a second equation to derive the upper boundary. For example the upper boundary can be used to denote an end of LED life situation, and the lower boundary can be used to denote a short circuit situation. The use of equations enables the functions to be adapted with changes to only a few parameters. Look up tables could be used instead, but require more effort to implement updated behaviour.

The invention also provides an LED driver arrangement, comprising:

a LED driver of the invention;

a current setting passive component for connection to the current setting input;

a voltage setting passive component for connection to the voltage or power setting input.

The current setting component and the voltage or power setting component can be accessible post manufacture of the LED driver, for example so that they can simply be connected to terminal pins of the driver to result in the desired driver configuration. This can be carried out by an equipment manufacture combining the driver with a luminaire to design an overall product. They can be on a PCB of the LED, within a connector wire, or within a connector.

The invention also provides a lighting system comprising:

an LED driver arrangement of the invention; and

an LED unit powered by the LED driver,

wherein the current setting passive component has a characteristic value which is used by the LED driver to determine the current level to provide to the LED unit, and the voltage setting passive component has a characteristic value which is used by the LED driver to determine the acceptable voltage range.

The invention also provides a method of driving an LED using a current driver, comprising:

measuring a characteristic value of a current setting passive component;

measuring a characteristic value of a voltage setting passive component;

deriving a current setting for the current driver from the current setting characteristic value;

deriving an acceptable voltage range from the voltage setting characteristic value; and

controlling the current driver to deliver the current setting; and

monitoring the output voltage to determine whether or not it falls within the acceptable range.

### BRIEF DESCRIPTION OF THE DRAWINGS

Examples of the invention will now be described in detail with reference to the accompanying drawings, in which:

FIG. 1 shows an example of an operating window of an LED driver;

FIG. 2 shows an example of a table for correlating a current setting resistor value to a desired output current;

FIG. 3 shows external connections to an LED driver to provide the external information in accordance with the invention;

FIG. 4 shows how different voltage setting resistor values are interpreted;

FIG. 5 shows the effect of the additional information provided by the invention on the way the driver supplies the load;

FIG. 6 shows the information used by the driver in delivering power to the load; and

FIG. 7 shows an example of circuit for measuring resistance.

### DETAILED DESCRIPTION

The invention provides an LED driver which uses a current setting passive component to set an operating current, and also uses a voltage or power setting passive component to derive an acceptable voltage or power range. A current driver is then controlled to deliver the current setting and monitor that a voltage or power being provided is within the acceptable voltage range.

As outlined above, it is known to set the current to be delivered to an LED load by selecting the value of an external resistor. The external resistor represents the desired output current of the LED driver to enable correct functioning of the LED within the specified current parameters of the LED. This output current setting is mainly used for operating window drivers.

The description below is based on the use of a current setting resistor, as well as a voltage setting resistor to implement the invention. This is for clarity, and other passive components can be used instead, such as inductors or capacitors. Essentially, any component can be used for which a characteristic value can be measured, and which value is then used to provide information. This can be an impedance or a threshold value or any other measurable value of a component.

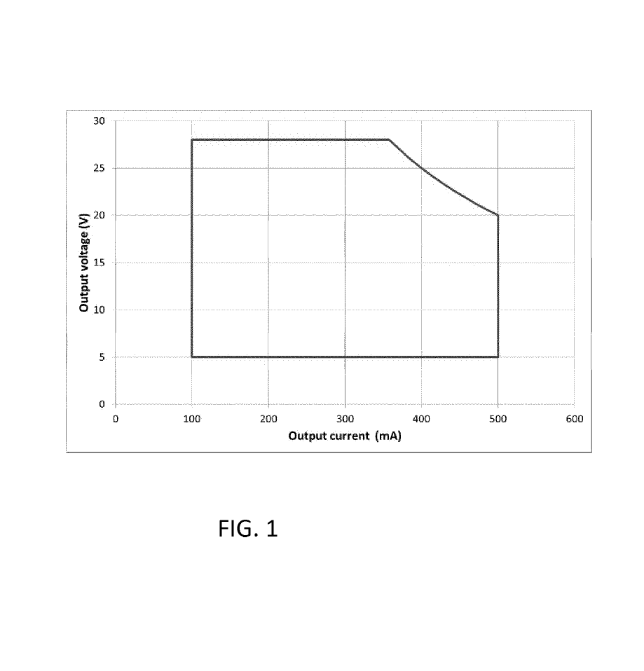

A typical operating window of a window driver is shown in FIG. 1, which shows a region of permitted current and voltage values. For this arbitrary example, the LED driver can deliver any load current between 100 mA and 500 mA. There is an allowed voltage of 5 to 28 Volts and a maximum power of 10 Watt. The maximum power setting defines the curved part of the region at the higher current and higher voltage regions, and the curve is of course defined by V(Volts)*I(Amps)<10.

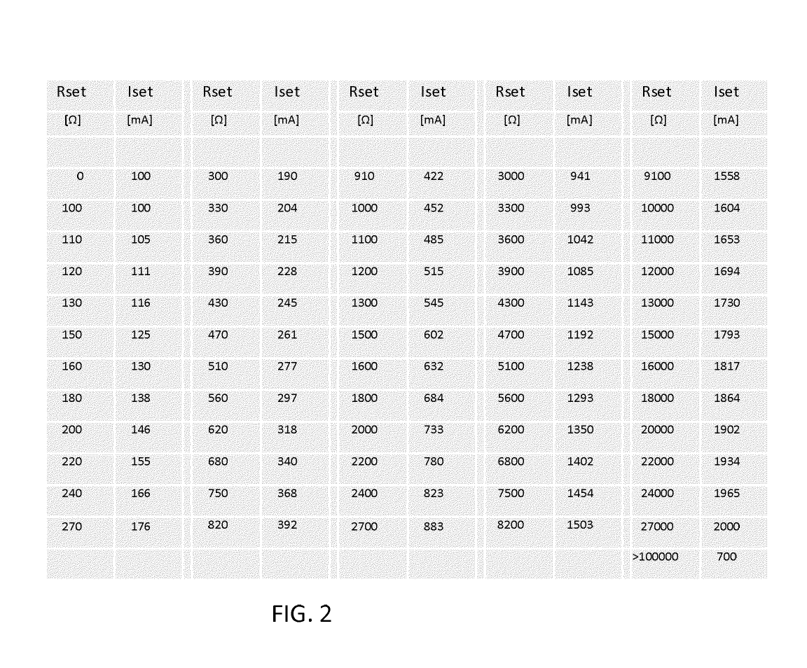

To select the correct resistor for a desired corresponding current, a table can be used as shown in FIG. 2.

The table shown is for an operating window with maximum current of 2000 mA.

When a resistor value above 100,000 ohms is measured, the output is limited to 700 mA. This is to safeguard the maximum output current, and it also defines a default output current if no current setting resistor is used.

As outlined above, one of the drawbacks of this operating window setting, especially for OLEDs, is that the OLED can be driven to much higher power than intended. For example, an OLED with a nominal operating point of 270 mA, 7.2 Volt, 1.9 Watt can be driven up to 270 mA, 28 Volt and thus a massive 7.6 Watt without any problems as seen from the driver side. The OLED however, driven at four times its nominal power, will become hot and possibly can cause unsafe situations as well as degrading very rapidly.

The invention provides a mechanism by which it is possible to let the LED driver know what the specification is of the connected load, so that the driver is able to maintain a valid and safe operation of the load.

In accordance with the invention, in addition to the use of an external setting passive components (such as a resistor) to derive the desired correct current, a second, voltage or power setting passive component is used to set voltage or power constraints.

The invention will be explained with reference to voltage setting, but it will be understood that the invention is conceptually the same as if applied to power setting.

As mentioned above, this component is a resistor in the detailed example below, but this is only by way of example.

This resistor will be denoted Rwin to reflect that in preferred examples it determines a voltage window.

The voltage setting can in the simplest implementation represent a nominal, minimum or maximum value, from which a maximum voltage can be defined, so that a voltage range is defined from the lower boundary of the operating window up to the maximum. However, a single resistor can instead be used to define multiple voltage trigger levels, thereby defining a window with upper and lower boundaries, by using an intelligent algorithm discussed further below.

The advantage of setting upper and lower voltage limits is that the minimum value of the voltage can correspond to the so-called short-circuit trigger level and the maximum value can correspond to the end of life (“EOL”) voltage of the LED.

The short-circuit trigger level relates in particular to failure of an organic LED due to a defect within the organic stack, where the current no longer flows with a uniform distribution, but through a single point. This can result in high local power consumption and heating.

In the same way as the current setting resistor, the voltage setting resistor can be placed on the LED, directly inserted in the output connector of the LED driver, or placed inside the LED connector or even inside the driver.

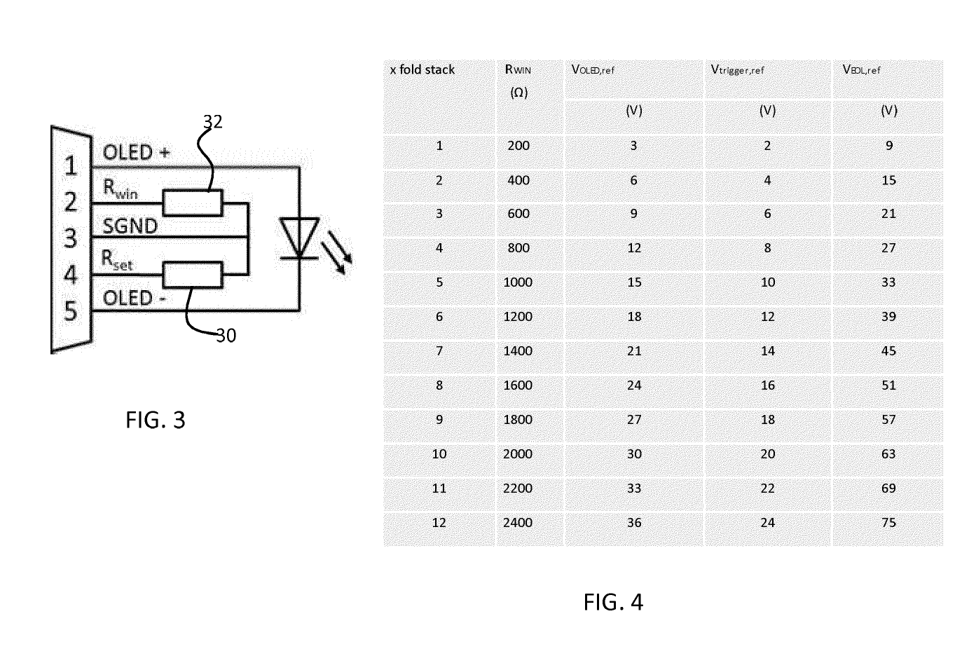

FIG. 3 shows one example of a set of external connections required to the driver to make use of both current setting and voltage setting resistors, and in which the resistors are both external. There are five terminals, comprising the two connections to the LED (OLED+, OLED−), a ground input (SGND) which is connected to one end of each of the current and voltage setting resistors, and separate inputs to the other resistor terminals (Rwin, Rset). These enable independent resistance measurement of the two resistors. The current setting resistor is shown as 30 and the voltage setting resistor is shown as 32.

The minimum allowed operating voltage, namely the lower trigger voltage, can be defined as:

Uminimum=RC*R_{WIN}+offset.

This is based on a linear function, but it is also possible to have a higher order function describing the voltage trigger.

In similar manner, a mathematical function can be defined for the nominal voltage and the maximum voltage of the voltage window. As mentioned above, the definitions can be based on the trigger level of the short-circuit protection. When the LED voltage is below this trigger, the channel should be switched off as the output is identified as a short-circuit. An upper trigger level can be for the end-of-life (EOL) voltage of the LED. Again this can be defined by a mathematical function.

Instead of being used simply as hard triggers in the driver, mathematical functions can be created to define advance warning triggers, for example that the LED is near end of life and that the LED should be soon replaced.

In preferred examples, these multiple triggers and settings can be derived from a single information source in the form of the voltage setting resistor.

An example will now be given of one possible set of equations.

The setting of the current is implemented by the current setting resistor Rset in known manner, for example using the table of FIG. 2. For example, a 400 mA LED would be associated with a resistor of 820 Ohm.

The actual operating voltage range of one example of OLED is calculated with the following formulas, which are also shown in generalised form:

Nominal LED voltage

U_{LED,ref}=3V/200Ω*Rwin

This can be generalised into a linear equation:

U_{LED,ref}=U_{LED,slope}*Rwin+U_{LED,offset}

Short circuit protection (SCP) voltage:

U_{trigger,ref}=2V/200Ω*Rwin

This can be generalised into a linear equation:

U_{trigger,ref}=U_{trigger,slope}*Rwin+U_{trigger,offset}

End of life voltage

U_{EOL,ref}=3V+6V/200Ω*Rwin

This can be generalised into a linear equation:

U_{EOL,ref}=U_{EOL,slope}*Rwin+U_{EOL,offset}

The parameters which describe these functions, namely U_{LED,slope}, U_{LED,offset}, U_{trigger,slope}, U_{trigger,offset}, U_{EOL,slope} and U_{EOL,offset} can be changed in the software by digital lighting addressable interface (“DALI”) commands.

Default values to provide the examples given above are thus

U_{LED,slope}=3V/200Ω, U_{LED,offset}=0V, U_{trigger,slope}=2V/200Ω, U_{trigger,offset}=0V, U_{EOL,slope}6V/200Ω, U_{EOL,offset}=3V.

The offset and slope parameters are not fixed, and they can be controlled using software which interfaces with the LED driver. The driver is in this way very flexible, and can be controlled to change the formula parameters while continuing to use the resistors in operation.

The software used to control the driver can also be designed such that when Rset and Rwin components are not detected, the operating window is set by internally defined formula parameters.

It can be arranged that only the driver manufacturer and/or the OEM luminaire builder can change these settings, rather than allowing the final end-user to change the settings.

For example, the LED driver can have three levels of software access. The LED driver manufacturer has full access, the equipment manufacture has a lower level of access, and the end user has an even lower level of access. The equipment manufacturer can select the Rwin and Rset values and connect these to the LED driver in order to tailor the LED driver to the lighting unit being driven in the equipment. The equipment manufacturer can also set maximum current values, for example, and can therefore tailor the operating window.

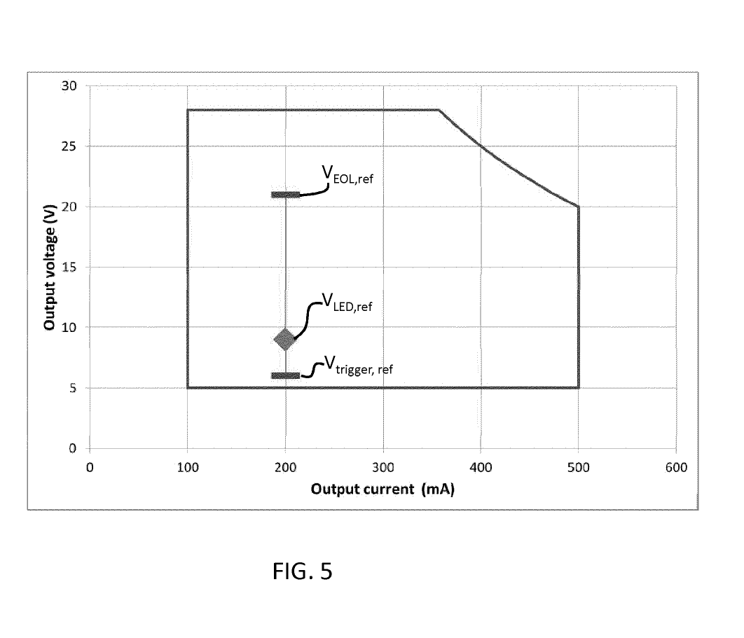

FIG. 4 shows the different trigger voltages which result from different voltage setting resistor values based on the default example above.

The column “x fold stack” reflects the fact that an OLED is typically built up out of stacks, in order to increase the light output of the OLED. Each stack has typically 3 Volts, so that each fold stack has 3 Volt reference voltage. The reference voltage is thus proportional to the number of “folds” in the stack.

For example, when the driver detects a current setting resistor of 330 Ohm (OLED current 204 mA as shown in FIG. 2) and a voltage setting resistor of 600 Ohm (Nominal OLED voltage 9 Volt, short circuit voltage 6 Volt, end of life voltage indicator 21 Volt), the valid operating window as shown in FIG. 5 results.

The nominal voltage is not needed to define the voltage window. However, it can for example be used to determine the difference between the nominal value (at t=0) and the EOL value. This enables an indication of the already used lifetime or the remaining lifetime of the OLED to be determined.

The linear formulae above are just an example. Higher order mathematical formulas are also possible to define the trigger levels.

Of course, since there is only one parameter being measured, the trigger levels and the nominal value are all correlated. However, the functions can be chosen to provide a suitable overall representation of the relationship between the short circuit voltage, the end of life voltage and the nominal voltage.

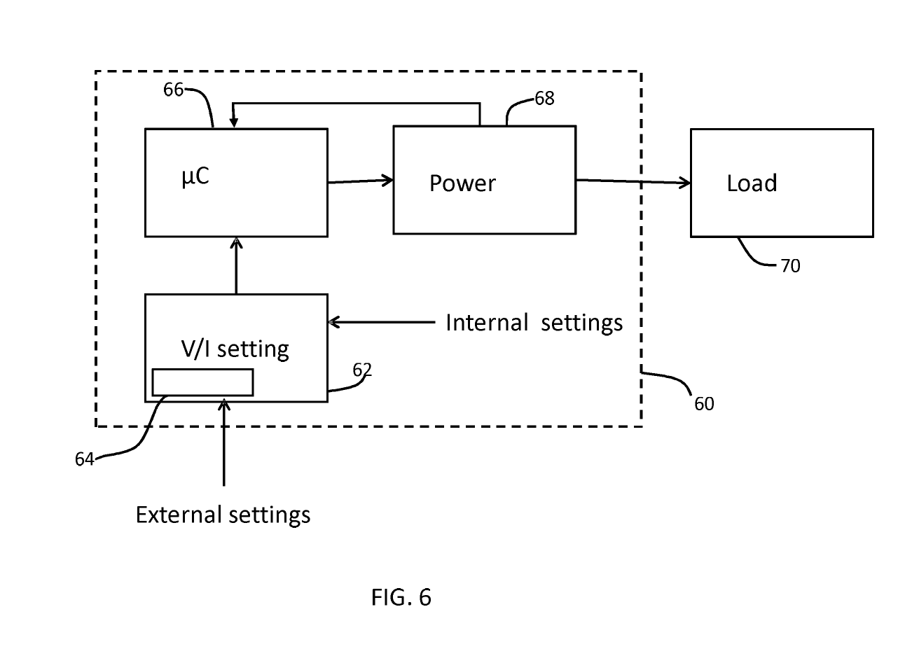

FIG. 6 shows a driver in accordance with one example of the invention. The driver is denoted by the dotted boundary 60. It comprises a setting interface 62 for setting the current and voltage window using the current setting resistor and voltage setting resistor as explained above.

The interface 62 receives internal settings which are for example set during production.

With the internal settings, it is possible to calibrate/fine-tune the settings of the driver to improve the quality of the driver. For example, a narrow tolerance on the output current can be obtained, and the channel-to-channel difference in a multi-channel driver can be reduced. It is also possible to fix the output window to one setting if the driver is to be supplied with an OLED as a single package. The Rset and Rwin components are then not needed, and that version of the driver can have the external setting function disabled.

The interface also receives external settings, for example determined from the resistor values. The interface includes a resistance measuring circuit 64 for measuring the resistance of the current setting resistor and the resistance of the voltage setting resistor.

The various setting information parameters are used by a controller 66 to control the power delivery circuitry 68 which delivers current to the LED load 70. A voltage feedback loop is shown from the power delivery circuit 68 to the processor 66 so that the voltage trigger levels are monitored by the controller 66.

In the event of trigger levels being exceeded, warning signals can be generated by the controller 66, or driving of the LED can be halted.

The controller 66 provides an intelligent control system for gathering information from an internal setup or an external setup for the current and the voltage window.

The resistance measuring circuit 64 is used for the detection of the value of the external resistors. As is known already for the measurement of the current setting resistor, the value of the resistance can be carried out by measuring a voltage at the R_{SET} and R_{WIN} pin (see FIG. 3) by means of an analogue to digital converter inside the controller 66.

There are many ways to measure an external connected resistor using current sources, opto-couplers for galvanic separation, op-amp application for attenuation or amplification, etc. Any known method for measuring a resistance value can be used within the driver 60.

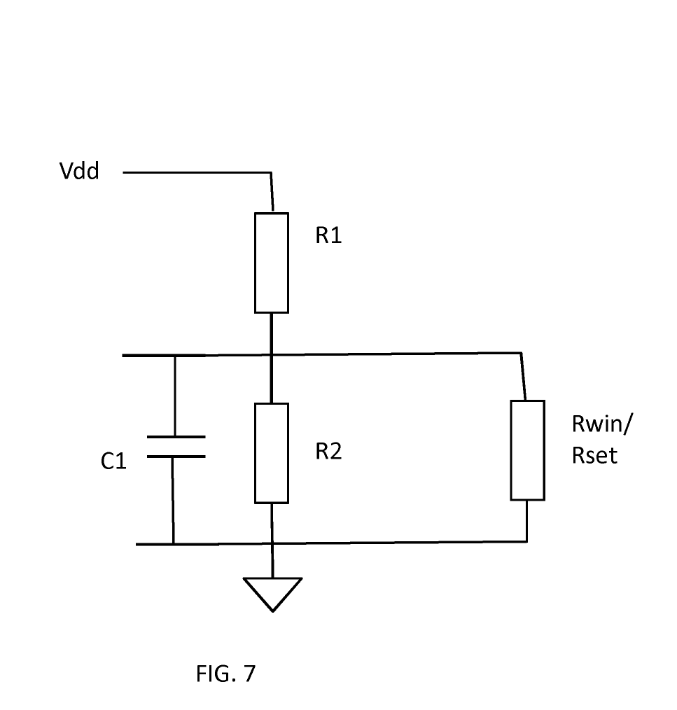

A simple example of a known measurement implementation is shown in FIG. 7.

The circuit has two resistors R1,R2 in series between a high power line Vdd and ground. The resistance to be measured Rwin or Rset is in parallel with the second resistor R2. The value of the resistor R2 is multiple times higher than the value of R1. If there is no external resistor connected, the voltage measured by the analogue to digital converter of the controller is nearly the same as Vdd. A holding capacitor is shown as C1.

When an external resistor is connected, the voltage drops, and the measured voltage drop can be used to derive the resistance value.

The example above makes use of a resistor for power or voltage setting. As mentioned above, other components can be used. If the characteristic value of the component has a similar temperature dependency to the OLED voltage, temperature compensation can be built in to the acceptable voltage or power range. For example, a Zener diode voltage can be measured, which has a similar temperature dependency to the OLED voltage. A negative temperature coefficient (NTC) resistor can also be used. The components may be single components or multiple components connected as a circuit.

The invention is of interest for organic and inorganic LED drivers.

The invention makes use of a controller. The controller can be implemented in numerous ways, with software and/or hardware, to perform the various functions discussed above. A processor is only one example of a controller which employs one or more microprocessors that may be programmed using software (e.g., microcode) to perform the required functions. A controller may however be implemented with or without employing a processor, and also may be implemented as a combination of dedicated hardware to perform some functions and a processor (e.g., one or more programmed microprocessors and associated circuitry) to perform other functions.

Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media such as volatile and non-volatile computer memory such as RAM, PROM, EPROM, and EEPROM. The storage media may be encoded with one or more programs that, when executed on one or more processors and/or controllers, perform at the required functions. Various storage media may be fixed within a processor or controller or may be transportable, such that the one or more programs stored thereon can be loaded into a processor or controller.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. An LED driver, comprising:
a current setting input for connection to a current setting passive component;
a voltage setting input for connection to a voltage or power setting passive component;
a measuring circuit for measuring a characteristic value of the current setting passive component and a characteristic value of the voltage or power setting passive component;
a controller; and
a current driver,
wherein the controller is adapted to:
derive a current setting for the current driver from the current setting characteristic value;
derive an acceptable voltage or power range from the voltage or power setting characteristic value; and
control the current driver to deliver the current setting and monitor the output voltage or power to determine whether or not it falls within the acceptable range.

2. An LED driver as claimed in claim 1, wherein the driver comprises an operating window driver having a current-voltage operating window.

3. An LED driver as claimed in claim 2, wherein the acceptable voltage/power range comprises upper and lower boundaries, wherein at most one of the upper and lower boundaries is on the edge of the current-voltage window.

4. An LED driver as claimed in claim 1, further comprising a look up table or algorithm for deriving a current setting from the current setting characteristic value.

5. An LED driver as claimed in any preceding claim, wherein the controller is adapted to derive the acceptable voltage or power range from the voltage setting characteristic value by applying a first equation to derive the lower boundary and by applying a second equation to derive the upper boundary.

6. An LED driver as claimed in claim 5, wherein the controller is adapted to derive a nominal operating voltage or power value from the voltage or power setting characteristic value by applying a third equation.

7. An LED driver arrangement, comprising:
an LED driver as claimed in any preceding claim;
a current setting passive component for connection to the current setting input;
a voltage or power setting passive component for connection to the voltage or power setting input.

8. An LED driver arrangement as claimed in claim 7, wherein the current setting passive component and the voltage or power setting passive component are accessible post manufacture of the LED driver.

9. A lighting system comprising:
an LED driver arrangement as claimed in claim 7 and
an LED unit powered by the LED driver,
wherein the current setting passive component has a characteristic value which is used by the LED driver to determine the current level to provide to the LED unit, and the voltage or power setting passive component has a characteristic value which is used by the LED driver to determine the acceptable voltage or power range.

10. A method of driving an LED using a current driver, comprising:
measuring a characteristic value of a current setting passive component;
measuring a characteristic value of a voltage or power setting passive component;
deriving a current setting for the current driver from the current setting characteristic value;
deriving an acceptable voltage or power range from the voltage or power setting characteristic value; and
controlling the current driver to deliver the current setting; and
monitoring the output voltage or power to determine whether or not it falls within the acceptable range.

11. A method as claimed in claim 10, wherein the driver comprises an operating window driver having a current-voltage operating window.

12. A method as claimed in claim 11, wherein the acceptable voltage or power range comprises upper and lower boundaries, wherein at most one of the upper and lower boundaries is on the edge of the current-voltage window.

13. A method as claimed in claim 10, further comprising deriving a nominal operating voltage or power value from the voltage or power setting characteristic value.

14. A method as claimed in claim 10, comprising deriving a current setting from the current setting characteristic value using a look up table or algorithm.

15. A method as claimed in claim 10, comprising deriving the acceptable voltage or power range from the voltage or power setting characteristic value by applying a first equation to derive the lower boundary and by applying a second equation to derive the upper boundary.
